(19) United States
(12) Patent Application Publication
(10) Pub. No.: US 2009/0239174 A1
(43) Pub. Date: Sep. 24, 2009

(54) FLUORESCENT MAGNETIC POWDER, METHOD OF MANUFACTURING THE SAME, MAGNETIC INK COMPOSITION, MAGNETIC POLYMER PARTICLE, LIQUID DEVELOPER FOR MAGNETIC LATENT IMAGE, CARTRIDGE, AND IMAGE FORMING APPARATUS

(75) Inventors: Yoshihiro Inaba, Kanagawa (JP); Takako Kobayashi, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/344,701

(22) Filed: Dec. 29, 2008

(30) Foreign Application Priority Data
Mar. 21, 2008 (JP) 2008-073206

(51) Int. Cl. G03G 9/12; C09D 11/02; G03G 15/10

(52) U.S. Cl. 430/112; 106/31.32; 399/237

(57) ABSTRACT

Fluorescent magnetic powder in which a fluorescent dye is attached to the particles of magnetic powder is provided.

### CROSS-REFERENCE TO THE RELATED APPLICATIONS

This application is based on and claims priority under 35 USC 119 from Japanese Patent Application No. 2008-073206, filed Mar. 21, 2008.

### BACKGROUND

1. Technical Field

The present invention relates to fluorescent magnetic powder, a method of manufacturing the fluorescent magnetic powder, a magnetic ink composition, magnetic polymer particles, a liquid developer for magnetic latent images, a cartridge, and an image forming apparatus.

2. Related Art

A magnetic printing apparatus capable of printing a required number of prints with one latent image formation has been disclosed. In this magnetic printing apparatus, a magnetic latent image magnetically formed is held on a magnetic recording medium (magnetic latent image holding member), and magnetic toner is supplied to the magnetic recording medium in a development section to visualize the magnetic latent image as a toner image. A recording medium such as paper is pressed to the magnetic recording medium in a transfer section, thereby transferring the visualized toner image onto the recording medium. Thereafter, the recording medium to which the image has been transferred is conveyed to a fixing section, and the transferred image is subjected to a fixing process to complete printing. This system is generally known as magnetography.

In the above system, since the magnetized state of the magnetic recording medium is maintained semi-permanently, once a latent image is formed, a large number of prints can be obtained by repeating the developing and transfer process. Further, since it is not necessary to re-record a latent image to obtain multiple prints, it is possible to satisfy demands for faster printing. Furthermore, the magnetism is stable with respect to environmental changes (especially changes in humidity) compared to static electricity.

Further, the magnetic latent image can be formed and erased magnetically with ease, and since a printing plate is unnecessary, production costs can be reduced.

As a specific example of the magnetographic process, magnetic toner may be supplied by a supply roller disposed at a position apart from a magnetic recording medium. The supply roller holds a magnetic toner layer on the peripheral surface of the supply roller, and brings the magnetic toner layer into contact with the magnetic recording medium so that the magnetic toner is supplied and adhered to a magnetic latent image on the magnetic recording medium.

As an image forming apparatus using the above process, a “dry” image forming apparatus using powdery magnetic toner has been disclosed.

### SUMMARY

According to an aspect of the invention, there is fluorescent magnetic powder including magnetic powder and a fluorescent dye that is attached to particles of the magnetic powder provided.

### BRIEF DESCRIPTION OF THE DRAWINGS

Exemplary embodiment of the present invention will be described in detail based on the following figure, wherein:

FIG. 1 illustrates a schematic configurational drawing of an image forming apparatus according to an exemplary embodiment.

### DETAILED DESCRIPTION

Hereinafter, the present invention will be explained based on exemplary embodiments in detail.

### <Fluorescent Magnetic Powder and Method of Manufacturing the Same>

In order to obtain magnetic particles that can exhibit magnetic property when used in various uses, and have excellent coloring characteristics in a color image and a color display by suppressing a color tinge as magnetic powder, covering the surface of the particles of magnetic powder with a fluorescent pigment and the like is effective, because of a high hiding ratio due to fluorescence. However, since the magnetic powder is not necessarily used singly, but is used by mixing with various media, the fluorescent pigment and the like are released from the surface of the particles of the magnetic powder, and as a result, the compensation owing to the fluorescence is not sufficiently achieved.

For this reason, the inventors have studied as to whether magnetic powder itself can be made as a product similar to a pigment having fluorescence, by firmly adhering a fluorescent dye and the like to the surface of the particles of the magnetic powder. As a result, it has been found that fluorescent magnetic powder which has a high hiding ratio due to the fluorescence of the surface of the particles of the magnetic powder, and which has fluorescent dye stably attached to the surface of the particles of the magnetic powder even if the fluorescent magnetic powder is used for various purposes, can be obtained, by covering the surface of the particles of the magnetic powder with a firm resin which is not eluted with a solvent and the like, as described hereinafter.

Fluorescent magnetic powder according to an exemplary embodiment of the invention includes magnetic powder and a fluorescent dye that is attached to particles of the magnetic powder.

Here, the “fluorescent dye is attached to particles of magnetic powder”, means that the change in weight of the fluorescent dye and resin is 20% by weight or less (ratio of weight loss with respect to the original weight of the fluorescent magnetic powder (the original weight of the fluorescent magnetic powder is 100% by mass)), when the fluorescent magnetic powder is extracted with ion exchange water and acetone as solvents by a Soxhlet extractor for 6 hours.

That is, in the fluorescent magnetic powder of the exemplary embodiment, the particles of the magnetic powder and the fluorescent dye are chemically bonded to each other, the fluorescent magnetic powder does not dissolve in an oily medium, and is easily dispersed in a hydrophilic medium without being dissolved therein, so that the degree of freedom of selection of media to be used becomes high. Moreover, in the fluorescent magnetic powder of the exemplary embodiment, since the reduction in the luminosity and saturation is suppressed, the fluorescent magnetic powder can be suitably used for a display material and printing material in color. In this case, for example, as magnetic polymer particles, which will be described later, the fluorescent magnetic powder can be used for not only toner, but also for fluorescent printing ink, fluorescent paint, fluorescent magnetic powder for penetrant inspection, paper-making additives, and analytical materials, in widespread use.

Hereafter, the constitution of the fluorescent magnetic powder of the exemplary embodiment will be explained together with the manufacturing method thereof. In the fluorescent magnetic powder of the exemplary embodiment, the constitution of the fluorescent magnetic powder is not specifically restricted, as long as a fluorescent dye is attached to particles of magnetic powder. The fluorescent magnetic powder may be, for example, fluorescent magnetic powder in which the fluorescent dye is attached to the particles of the magnetic powder via a resin that is provided on the surface of the particles of the magnetic powder. The resin may have a functional group and the fluorescent dye may be attached to the particles of the magnetic powder by reacting with the functional group.

The fluorescent magnetic powder may be, for example, fluorescent magnetic powder in which a resin having a functional group is provided on the surface of the particles of the magnetic powder first, and the fluorescent dye is reacted with the functional group so that the fluorescent dye is bond to the resin. In this case, the resin formed on the surface of the particles of the magnetic powder is firm, and, of course, it is not dissolved and exfoliated with a solvent or the like. Further, the resin may be either chemically bonded to or not chemically bonded to the surface of the particles of the magnetic powder.

In particular, the fluorescent magnetic powder having the above structure may be obtained by the manufacturing method including; hydrophobizing the surface of the particles of the magnetic powder by treating the surface of the particles of the magnetic powder with a coupling agent (hydrophobizing step); forming a resin having a functional group on the hydrophobized surface of the particles of the magnetic powder (resin forming step); and attaching a fluorescent dye to the particles of the magnetic powder by reacting the fluorescent dye with the functional group of the resin (attaching step).

Hereafter, the method will be explained in accordance with each step.

(Hydrophobizing Step)

The hydrophobizing step is a step of treating the surface of the particles of the magnetic powder with a coupling agent to hydrophobizing the surface. By hydrophobizing the surface of the particles of the magnetic powder, an adhesive force of the particles of the magnetic powder with the resin to be formed can be enhanced, and exfoliation of the resin when the resin comes in contact with a solvent or is allowed to stand for a long time can be prevented.

In the exemplary embodiment, the magnetic powder includes, for example, iron materials such as pure ion and carbonyl iron, iron oxides such as magnetite (Fe₃O₄), maghemite (γ-Fe₂O₃), Mn—Zn system ferrites, Ni—Zn system ferrites, Mn—Mg system ferrites, Li system ferrites, and Cu—Zn system ferrites. In particular, it is desirable to use carbonyl iron and pure iron especially from the viewpoint of being suitable for magnetic particles for cyan color or blue color.

Examples of methods of manufacturing the iron powder containing iron as a constituent component include the following five methods.
(1) mill scale reduction iron powder method: mill scale generated in the process of rolling of steel materials is reduced with coke;
(2) ore reduction iron powder method: iron ore is used as a raw material, and is subjected to the same process as the above;
(3) atomizing iron powder method: melted iron flown out from pores is pulverized with high-pressure water and high-pressure gas;
(4) electrolytic iron powder method: iron is electrolytically deposited from an aqueous solution containing iron such as iron sulfate and iron chloride; and
(5) carbonyl iron powder method: iron is pulverized by adding steam to carbonyl iron Fe(CO)₅ to be pyrolyzed.

The carbonyl iron powder refers to the iron powder obtained by the method of (5) in the above.

Further, as other metal oxides, nonmagnetic metal oxides in which one or more of metals such as Mg, Al, Si, Ca, Sc, Ti, V, Cr, Mn, Fe, Co, Ni, Cu, Zn, Sr, Y, Zr, Nb, Mo, Cd, Sn, Ba, and Pb are used, and the above described magnetic metal oxides can be used. For example, as the nonmagnetic metal oxides, Al₂O₃, SiO₂, CaO, TiO₂, V₂O₅, CrO₂, MnO₂, Fe₂O₃, CoO, NiO, CuO, ZnO, SrO, Y₂O₃, ZrO₂ systems, and the like can be used.

In particular, it is desirable to use yttrium.iron.gamet (Y₃Fe₅O₁₂, YIG) from the viewpoint of being suitable for magnetic color particles for yellow, green, magenta, or red color.

The average primary particle size of the particles of the magnetic powder before hydrophobizing treatment, which will be described later, is preferably in the range of from 0.02 μm to 2.0 μm. When the average primary particle size of the particles of the magnetic powder is in the above range, the particles are not easily aggregated and are homogeneously dispersed in a polymerizable monomer with ease. Further, the “homogeneity” relating to the dispersion refers to the state where aggregates being comparable in size to aggregates of about ten primary particles of the magnetic powder do not exist in the system. This is applicable to the following descriptions.

As described above, the hydrophobizing treatment needs to be performed by treatment with a coupling agent. The coupling agents include, for example, a silane coupling agent, a titanium coupling agent, and the like. The silane coupling agent is used more suitably, and, for example, the silane compound having the structure shown by the following Formula (A) is used.

RmSiYn Formula (A)

In Formula (A), R represents an alkoxy group, m represents an integer of from 1 to 3, Y represents a hydrocarbon group such as an alkyl group, a vinyl group, a glycidoxy group, and a methacryl group, and n represents an integer of from 1 to 3.

Specifically, for example, vinyl trimethoxy silane, vinyl triethoxy silane, γ-methacryloxy propyl trimethoxy silane, vinyl triacetoxy silane, methyl trimethoxy silane, methyl triethoxy silane, isobutyl trimethoxy silane, dimethyl dimethoxy silane, dimethyl diethoxy silane, trimethyl methoxy silane, hydroxy propyltrimethoxy silane, phenyl trimethoxy silane, phenethyl trimethoxy silane, n-hexadecyl trimethoxy silane, n-octadecyl trimethoxy silane, and the like can be exemplified.

In particular, an alkyl trialkoxy silane coupling agent represented by CₚH₂ₚ₊₁—Si—(OC_{q}H_{2q+1})₃ (wherein, p represents an integer of from 2 to 20, and q represents an integer of from 1 to 3), and an aralkyl trialkoxy silane coupling agent represented by C₆H₅—CᵣH₂ᵣ—Si—(OCₛH₂ₛ₊₁)₃ (wherein, r represents an integer of from 2 to 20, and s represents an integer of from 1 to 3) are preferably used to phydrophobize magnetic powder. The “aralkyl” used here refers to a hydrocarbon group having both an aromatic structure and an aliphatic structure. That is, a hydrogen atom of an alkyl group is substituted with a substituted or an unsubstituted aryl group. Examples of the aralkyl group include a benzyl group, a phenethyl group, α-mesityl group, and the like.

Moreover, in the exemplary embodiment, as the silane coupling agent, it is particularly desirable to use a polymerizable group-containing silane coupling agent represented by the following Formula (1);

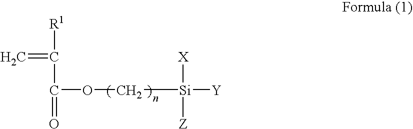

Here, in Formula (1), n represents an integer of from 1 to 18, R¹ represents a hydrogen atom or a methyl group, and X, Y, and Z each independently represent a halogen atom, an alkyl group or an alkoxy group. Further, the halogen atom is preferably a chlorine atom, the alkyl group is preferably a methyl group or an ethyl group, and the alkoxy group is preferably a methoxy group, an ethoxy group or a propoxy group.

When the silane coupling agent represented by Formula (1) is used, since a vinyl group exists on the surface of the particles of the magnetic powder after the treatment with the use of a silane coupling agent represented by Formula (1), the vinyl group can react with a monomer for forming a resin in polymerization reaction when the resin is formed, which will be described later, and therefore, the resin may be chemically bonded to the surface of the particles of the magnetic powder with the formation of the resin.

As the hydrophobizing treatment of magnetic powder, commonly known methods can be used such that, for example, when a silane coupling agent is used, a dry treatment in which a vaporized silane coupling agent is reacted with a cloud form formed by stirring the magnetic powder, a wet method in which a silane coupling agent is added dropwise to and reacted with the magnetic powder dispersed in a solvent, or a method in which after a silane coupling agent is mixed with the magnetic powder dispersed in a solvent, the solvent is evaporated by use of a distillation apparatus such as a rotary evaporator, and magnetic powder, to which the silane coupling agent is adhered, is subjected to a heat treatment. Moreover, the above hydrophobizing treatments can also be used in combination.

The treatment amount of the coupling agent relative to the magnetic powder in the hydrophobizing treatment is preferably in the range of from 0.05 parts by weight to 20 parts by weight with respect to 100 parts by weight of the magnetic powder, and more preferably in the range of from 0.1 parts by weight to 10 parts by weight with respect to 100 parts by weight of the magnetic powder.

(Resin Forming Step)

Next, a resin is formed on the hydrophobized surface of the particles of the magnetic powder. The resin for constituting the resin is not particularly restricted, and examples thereof include cellulose, cellulose acetate, a polyamide, an epoxy resin, a polyester, a melamine resin, a polyurethane resin, a vinyl resin, a silicone resin, a polymer or a copolymer of an acrylic ester, a methacrylic ester, styrene, ethylene, propylene, and derivatives thereof.

The resin may be formed as a resin layer.

Further, the particles of the fluorescent magnetic powder of the exemplary embodiment may have functional groups on the surface of the resin formed thereon, for allowing the functional group to react with a fluorescent dye. For this reason, the resin for constituting the resin may be a polymer of the monomer having the functional groups.

Furthermore, examples of the functional group include a hydroxyl group, a carboxyl group, a carboxylic halide group, a carboxylic anhydride group, an amino group, an alkyl halide group, an isocyanate group, an epoxy group, and the like, and in addition to these groups, an ionic group is also effective.

The method of forming the resin is not specifically limited, but, the resin can be directly formed on the surface of the particles of the magnetic powder in such methods that, for example, a dip coating method, in which magnetic powder is immersed in a cover layer-forming solution with the use of the cover layer-forming solution formed by dissolving or dispersing a resin in a solvent, a spray method in which the cover layer-forming solution is sprayed on the surface of magnetic particles, and a kneader coater method, in which magnetic particles are mixed with a the cover layer-forming solution in a state that the magnetic particles are made to float with flowing air, and the solvent is removed.

However, in the exemplary embodiment, a resin may be formed on the surface of the particles of the magnetic powder in such a manner that the particles of the hydrophobized magnetic powder are introduced into a polymerizable component containing monomers and the like having the functional groups, and a polymerization reaction may be performed by adding a polymerization initiator and the like thereto.

In the above method of forming a resin, a resin layer can be uniformly formed on the surface of each of the particles of the magnetic powder without variation in thickness of the resin layer for each particle, so that aggregation of the particles of the magnetic powder after forming the resin layer can also be prevented.

As the monomers or oligomers, for example, a monomer or an oligomer such as (meth)acrylic acid, (meth)acryloyloxy ethyl monophthalte, (meth)acryloyloxy propyl monophthalate, (meth)acryloyloxy butyl monophthalate, (meth)acryloyloxy ethyl monosuccinate, (meth)acryloyloxy propyl monosuccinate, (meth)acryloyloxy butyl succinate, (meth)acryloyloxy ethyl maleate, glycidyl methacrylate, 2-methacryloyloxy ethyl isocyanate, 2-([1′-methylpropylideneamino]carboxyamino) ethyl methacrylate, 2-[(3,5-dimethylpyrazolyl)carboxyamino] ethyl methacrylate, methyl acrylate, ethyl acrylate, and butyl acrylate; a monomer or an oligomer such as an alkyl acrylate, methyl methacrylate, ethyl methacrylate and butyl methacrylate; and a monomer or an oligomer such as an alkyl methacrylate, styrene, diallylphthalate, vinyl ether, vinyl ester, acrylonitrile, and vinyl chloride, and the like, can be used.

Further, as the polymerization initiator, organic peroxide compounds such as acetyl peroxide, dibutyl peroxide, lauryl peroxide, and benzoyl peroxide, or azo initiators such as 2,2′-azobis-(2,4-dimetyl valeronitrile), 2,2′-azobis-(2-butylonitrile), 2,2′-azobis-isobutylonitrile, dimethyl-2,2′-azobis-isobutylate and 1,1′-azobis-(cyclohexane-1-carbonitrile), can be suitably used.

In the exemplary embodiment, as a monomer used for forming the resin, at least one of the compounds represented by the following Formula (2) and the compounds represented by the following Formula (3), may be used.

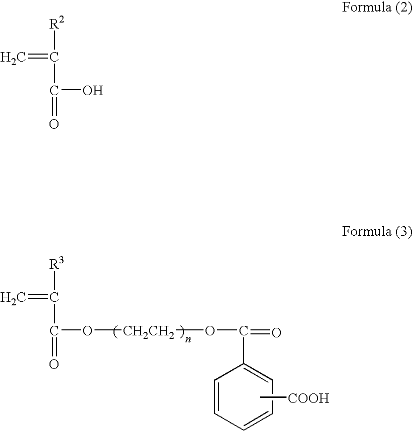

Here, in Formulae (2) and (3), R² and R³ each independently represent a hydrogen atom or a methyl group, and n represents an integer of from 1 to 18.

The resins formed by polymerizing the monomers having the above structures are very tough, although the reason is not clear, and the resins are not easily dissolved in an organic solvent singly. Accordingly, in the exemplary embodiment, it is suitable to form a resin layer containing the resin on the surface of the particles of the magnetic powder.

When the monomer is used for polymerization to form a resin, the weight average molecular weight of the resin is preferably from 1,000 to 1,000,000, and more preferably from 10,000 to 500,000.

If the weight average molecular weight is 1,000 or more, the resin formed may be more excellent in toughness, so that the resin is less likely to be dissolved when coming into contact with a solvent. If the weight average molecular weight exceeds 1,000,000, the reaction of the resin with a fluorescent dye may be retarded.

Moreover, the thickness of the resin layer may be from 10 nm to 1,000 nm.

The particles of the magnetic powder having a resin thereon may have functional groups on the surface thereof, and, in the case of the functional groups being carboxyl groups, the amount of the carboxyl groups is preferably from 0.1 mmol to 3.0 mmol, and more preferably, from 0.5 mmol to 1.0 mmol.

The amount of the carboxyl groups can be measured as follows;

The particles of the magnetic powder with a resin thereon are weighed first, the weighed particles of the magnetic powder are placed in a test tube with a cap, 5 ml of DMF is added thereto, and the mixture is dispersed for 1 hour using an ultrasonic stirrer. The total dispersed liquid is collected in a conical beaker, and titrated with an ethanolic potassium hydroxide solution (manufactured by Wako Pure Chemical Industries, Ltd.) with a concentration of 0.1M, using phenolphthalein (manufactured by Wako Pure Chemical Industries, Ltd.) as an indicator.

A blank experiment, in which the particles of the magnetic powder are not used, is also conducted and the amount of carboxyl groups (mmol/g) is calculated from the difference in the titration amounts between the sample and the blank experiment according to the following Equation (1).

Amount of carboxyl groups=((F−E)×0.1×f)/W Equation (1)

In Equation (1), E is an amount (ml) of titration in the blank experiment, and F is an amount (ml) of titration in the sample, f is the factor of the potassium hydroxide solution and W is the weight (g) of the resin in the magnetic powder. Here, the weight W of the resin is obtained by a thermogravimetric analysis (TGA) of the particles of the magnetic powder having the resin thereon, in accordance with Equation (2) for iron powder, and Equation (3) for YIG.

W=Z×(X−Y/1.43)/X Equation (2)

W=Z×(X−Y)/X Equation (3)

In equation (2), Z is an amount (g) of magnetic powder used for measuring the amount of carboxyl groups, X is an amount (g) of magnetic powder used for the thermogravimetric measurement, and Y is an amount (g) of residual substances after the thermogravimetric measurement up to 600° C. The numeral “1.43” is a numerical value for correcting an increase in weight due to oxidation from iron to iron oxide in a thermobalance, in the case that the magnetic powder is iron. The thermogravimetric measurement is performed in accordance with the thermogravimetric measurement after the fluorescent dye attaching process, which will be described later.

(Attaching Step)

Next, a fluorescent dye is allowed to react with the functional groups which exist on the surface of the resin to attach the fluorescent dye onto the resin.

Examples of the fluorescent dye include naphthalimides; cationic or non-cationic coumarins, xanthenodiquinolizines (for example, sulforhodamines); azaxanthenes; naphtholactams; azlactones; oxazines; thiazines; dioxazines; azo, azomethine or methine type monocationic or polycationic fluorescent dye single compound or mixture thereof, and preferably naphthaluids; cationic or non-cationic coumarins; azaxanthenes; naphtholactams; azlactones; oxazines; thiazines; dioxazines; azo, azomethine or methine type monocationic or polycationic fluorescent dye single compound or mixture thereof.

More specifically, C. I. Fluorescent Brightening Agent −14, −24, −30, −32, −52, −54, −69, −79, −84, −85, −86, −87, −90, −104, −112, −113, −114, −119, −121, −134, −135, −152, −166, −167, −168, −169, −191, −192, −201, −204, −214, −216, −217, −218, −223, −226, −229, −234, −236, −239, −240, −242, −257, −260, −271, −290, −310, −311, −312, −313, −314 and −315; C. I. Basic Red 1, −2, −9, −12, −13, −14, and −17; C. I. Basic Violet 1, −3, −7, −10, −11 and −14; C. I. Basic Yellow 2, −9, −35, −40, −44 and −95; C. I. Solvent Yellow 160:1 and −98; C. I. Disperse Orange 47; C. I. Basic Violet 11:1; C. I. Basic Blue 7and −45; C. I. Acid Red 51, −52, −92, −94; C. I. Acid Blue 9; C. I. Acid Yellow 7 and −23; C. I. No. 59075, −45170, −45160 and −48070; C. I. Acid Red 52, −87 and −92; C. I. Acid Black 2, and the like are exemplified.

When a color displayed with a magnetic ink composition or magnetic polymer particles, which will be described later, is yellow, Basic Yellow 2, Basic Yellow 40, or the like is preferably used, and when a displayed color ranges from magenta to reddish, Basic Red 1, Basic Violet 10, or the like is preferably used.

The reaction between the functional group of the resin and fluorescent dye is not specifically restricted, but a salt exchange reaction, an acid-base reaction, an addition reaction, or the like can be selected and used in accordance with conditions, and the like.

For example, in the case of the salt exchange reaction, a carboxyl group as the functional group on the surface of the resin first is subjected to a neutralization reaction with a base such as NaOH to form a salt (neutralization salt) structure, and subsequently the neutralization salt is subjected to a salt exchange reaction with a cationic fluorescent dye to combine the resin with the fluorescent dye.

Further, in the case of the acid-base reaction, for example, a resin is formed with the use of a resin formed by polymerizing monomers represented by Formula (2) or Formula (3), and the resin is subjected to an acid-base reaction to combine a fluorescent dye having an amino group with the resin.

Furthermore, in the case of the addition reaction, an isocyanate group, a block isocyanate group or a glycidyl group as a functional group on the surface of the resin is reacted with an amino group, a hydroxyl group or a carboxyl group existing in a fluorescent dye molecule to combine the resin with the fluorescent dye.

In any case of utilizing the above reactions, the fluorescent dye is preferably combined with 1% or more of all the functional groups on the surface of the resin, and is more preferably combined with 10% or more of all the functional groups on the surface of the resin (hereafter, this may be called an attachment ratio).

When the attachment ratio is 1% or higher, the quantity of the fluorescent dye on the surface of the particles of the magnetic powder becomes more sufficient, and a hiding property with the fluorescence may be further improved. The attachment ratio can be obtained, for example, in such a manner that the amount of the functional groups of the particles of the fluorescent magnetic powder is measured (that is, the amount of the functional groups of the particles of the fluorescent magnetic powder obtained after the reaction of a fluorescent dye and the particles of the magnetic powder, is measured), and is compared with the amount of the functional groups before the reaction.

According to the steps explained in the above, the fluorescent magnetic powder of the exemplary embodiment can be suitably obtained.

As described above, “fluorescent dye is attached to particles of magnetic powder” in the exemplary embodiment, means that the change in weight of the fluorescent magnetic powder (ratio of weight loss with respect to the original weight of the fluorescent magnetic powder, when the original weight of the fluorescent magnetic powder is set to 100% by weight) in a Soxhlet extraction with ion exchange water and acetone as solvents, is 20% by weight or less, and the change in weight of the fluorescent magnetic powder is more preferably 10% by weight or less.

Moreover, in the obtained fluorescent magnetic powder of the exemplary embodiment, the amount (amount of attached components) of components of the fluorescent dye other than the magnetic powder (for example, the components other than the magnetic powder includes the resin and the fluorescent dye), is desirably from 5.0% by weight or about 5.0% by weight to 50% by weight or about 50% by weight, and more desirably from 10% by weight or about 10% by weight to 30% by weight or about 30% by weight.

If the amount of the components is 5.0% by weight or higher, attaching of fluorescent dye may be more sufficient, or the hiding property due to the fluorescence may be further improved. If the amount is 50% by weight or less, the particle size of the magnetic powder may be effectively maintained at a favorable size, and image quality may be further improved when the fluorescent magnetic powder is used for a magnetic ink.

In addition, the amount of the components other than the magnetic powder can be obtained as a ratio (%) in such a manner that a thermogravimetric analysis (TGA) is performed from room temperature (20° C.) to 600° C., and a weight loss is measured, and the value of the weight loss is divided by the initial weight of the measurement sample of the fluorescent magnetic powder prepared. When the magnetic powder is iron powder, since iron is oxidized to iron oxide during the TGA measurement, correction shown by the above Equation (2) is required.

As an alternative measurement method, the fluorescent magnetic powder is measured with a vibrating sample magnetometer (VSM), and the weight of the magnetic powder in the fluorescent magnetic powder based on the obtained magnetic property and the magnetic property before the magnetic powder is treated, so that the amounts of the components other than the magnetic powder can be calculated.

<Magnetic Ink Composition>

The magnetic ink composition of the exemplary embodiment includes at least the fluorescent magnetic powder of the above exemplary embodiment.

The magnetic ink composition of the exemplary embodiment may be, for example a composition including the fluorescent magnetic powder and a vehicle. The magnetic ink composition of the exemplary embodiment may further include a coloring matter. The coloring matter may be, for example, a pigment or a dye.

The magnetic ink composition of the exemplary embodiment may be, for example, a composition including the fluorescent magnetic powder, a coloring matter, a vehicle formed by combining an oil, a resin, a dispersing solvent and the like, as well as other additives.

In this case, specific examples of the dye include Fast Yellow G, Hansa Brilliant Yellow 5GX, Disazo Yellow AAA, Naphthol Red HFG, Lake Red C, Benzimidazolone Carmine HF3C, Dioxazine Violet, Phthalocyanine Blue, Indacothorone Blue, Phthalocyanine Green, Benzimidazolone Brown HFR, carbon black, aniline black, titanium oxide, Tartrazine Lake, Rhodamine 6G Lake, Methyl Violet Lake, Basic 6G Lake, Brilliant Green Lake, Nigrosine, and the like.

Further, the vehicle may include an oil, a resin, a dispersing solvent and the like. Specific examples of the oils include, for example, linseed oil, tung oil, soybean oil, castor oil, dehydrated castor oil, lithovarnish, maleated oil, vinylated oil, urethane oil, machine oil, spindle oil, and the like. Examples of the resins include rosin, shellac, copal, dammar, gilsonite, zein, lime rosin, ester gum, phenol resin, xylene resin, urea resin, melamine resin, ketone resin, coumarone/indene resin, petroleum resin, terpene resin, cyclized rubber, chlorinated rubber, alkyd resin, polyamide resin, acrylic resin, polyvinyl chloride, vinyl chloride/vinyl acetate copolymerized resin, polyvinyl acetate, polyvinyl alcohol, polyvinyl butyral, chlorinated polypropylene, styrene resin, epoxy resin, polyurethane, cellulose derivatives, and the like.

Moreover, examples of the dispersing solvents include n-hexane, n-heptane, toluene, xylene, methyl alcohol, isopropyl alcohol, ethylene glycol, triethylene glycol, diethylene glycol, glycerin, methyl cellosolve, carbitol, ethyl acetate, acetone, methyl ethyl ketone, and the like.

In addition, examples of the additives include waxes, dryers, wetting agents, crosslinking agents, stabilizers, gelling agents, defoaming agents, photopolymerization initiators, and the like. Furthermore, when color ink, paint or the like is prepared, components such as a thickening agent for increasing the viscosity thereof, a fluidizing agent for reducing the viscosity thereof, a dispersant for dispersing particles, and the like may be included as additives.

The content of the fluorescent magnetic powder in the magnetic ink composition according to the exemplary embodiment, is preferably from 1.0% by weight to 50.0% by weight, and more preferably 3.0% by weight to 40.0% by weight with respect to the total content of the ink composition.

When the content is 1.0% by weight or higher, further improved magnetic property for ink or a coated layer may be obtained. If the content is 50.0% by weight or less, luminosity and color saturation may be further improved, when displaying a color.

The thus obtained magnetic ink composition can suitably be used not only for a composition for printing for color display, ink-jet printers, heat transfer, hot melt printers, writing utensils, and displays, but also for a composition for fluorescence printing inks, fluorescent paints, and the like. Furthermore, magnetic signals can be added with the contained fluorescent magnetic powder, and the signals can be read-out by a magnetic head, and the signals can also be used for information addition or maintenance of information for printing the information on magnetic cards such as certificates and tickets, or printing on bills, secret documents, and the like.

The control of color hue is easy at the time of printing even if adding magnetic powder, so that colors excellent in luminosity and color saturation can be displayed.

<Magnetic Polymer Particles>

The magnetic polymer particles of the exemplary embodiment contain at least the fluorescent magnetic powder of the above exemplary embodiment. The magnetic polymer particles of the exemplary embodiment may contain the magnetic polymer fluorescent magnetic powder dispersed in a binder resin.

Specifically, the magnetic polymer particles may include, for example, a polymer compound as a binder resin, and the fluorescent magnetic powder, wherein the fluorescent magnetic powder is dispersed in the polymer compound as a binder resin. The magnetic polymer particles may further include a coloring material required for forming a color image, and other requisite components. The magnetic polymer particles may include, for example, the fluorescent magnetic powder dispersed in a binder resin, and a pigment.

The magnetic polymer particles of the exemplary embodiment are magnetic polymer particles in a particulate form that may be suitably used for a developer for liquid magnetography, as described later. Accordingly, the polymer particles may be dispersible in an aqueous medium such as water without variation (homogeneously) while maintaining a magnetic force at a predetermined level or higher.

Here, the “magnetic polymer particles” refers to magnetic powder-dispersed particles that include magnetic powder dispersed in a polymer.

Polymer Compound

Examples of the polymer compounds include homopolymers or copolymers of the following compounds: styrenes such as styrene and chlorostyrene; monoolefins such as ethylene, propylene, butylene and isoprene; vinyl esters such as vinyl acetate, vinyl propionate, vinyl benzoate; α-methylene aliphatic monocarboxylic esters such as methyl acrylate, ethyl acrylate, butyl acrylate, dodecyl acrylate, octyl acrylate, phenyl acrylate, methyl methacrylate, ethyl methacrylate, butyl methacrylate, dodecyl methacrylate; vinyl ethers such as vinyl methyl ether, vinyl ethyl ether and vinyl butyl ether; vinyl ketones such as vinyl methyl ketone, vinyl hexyl ketone and vinyl isopropenyl ketone.

In the above, examples of suitable polymers include polystyrene, styrene-alkylacrylate copolymer, styrene-alkylmethacrylate copolymer, styrene-acrylonitrile copolymer, styrene-butadiene copolymer, styrene-maleic anhydride copolymer, polyethylene, polypropylene, and the like. Examples of the polymer further include polyester, polyurethane, epoxy resin, silicone resin, polyamide, modified rosin, paraffin and waxes can be exemplified.

In the exemplary embodiment, a polymer formed by polymerizing at least one of (meth)acrylate monomers and styrene-based monomers may be suitably used as the polymer compound. Hereinafter, the polymer formed by polymerizing at least one of (meth)acrylate monomers and styrene-based monomers will be explained in detail.

Here, the (meth)acrylate represents an acrylate or methacrylate, and “(meth)acrylate” means “(meth)acrylic ester” as usually used, and the styrene-based monomer means styrene and styrene derivatives. The above is applicable to the following descriptions.

In (meth)acrylate monomer, an alkyl group in the alcohol residue of the (meth)acrylic ester is preferably a substituted or unsubstituted alkyl group having 1 to 18 carbon atoms. For example, the alkyl groups include a methyl group, an ethyl group, an n-propyl group, an isopropyl group, an n-butyl group, a t-butyl group, a pentyl group, an isopentyl group, a neopentyl group, a hexyl group, a heptyl group, an n-octyl group, a nonyl group, a decyl group, an undecyl group, a dodecyl group, and the like. Further, a benzyl group, a hydroxyethyl group, and a hydroxyethyl group in which a hydroxyl group is protected by a hydrophobic protective group such as dihydropyrane, and a polyoxyethylene group, may be used. In consideration of dispersibility of polymer particles in water, the polymer compound may be, for example, a polymer containing a hydroxyethyl methacrylate group, or a polymer in which a (meth)acrylate polymer is further modified with a (poly)ethylene glycol.

Examples of the styrene-based monomer include a vinyl group-containing monomer having a substituted or unsubstituted aryl group having 6 to 12 carbon atoms. Example of the aryl group include a phenyl group, a naphthyl group, a tolyl group, a p-n-octyloxy phenyl group, and among them, a phenyl group is preferable.

Further, examples of the substituent in the alkyl group of the (meth)acrylate monomer, and a substituent in the aryl group of the styrene-based monomer include: an alkyl group, an alkoxy group, a halogen atom, an aryl group.

Examples of the alkyl group of the substituent include the aforementioned alkyl groups. Examples of the alkoxy groups of the substituents include a methoxy group, an ethoxy group, a propoxy group, a butoxy group, and among them, a methoxy group and an ethoxy group are preferable. Examples of the halogen atom include a fluorine atom, a chlorine atom, a bromine atom and an iodine atom, and among them, a fluorine atom and a chlorine atom are preferable. Examples of the aryl group include the aforementioned aryl groups.

When both the (meth)acrylate monomer and the styrene-based monomer are used as monomers, the content ratio of the (meth)acrylate monomer to the styrene-based monomer in the mixture ((meth)acrylate/styrene-based monomer) is preferably from 95/10 to 5/95 by molar ratio, and more preferably from 90/10 to 10/90 by molar ratio.

Moreover, in addition to the polymer component of the above monomers, other monomers may further be added and for copolymerization, in the magnetic polymer particles of the exemplary embodiment.

The polymer compound in the exemplary embodiment may be a polymer which is further copolymerized with a crosslinkable monomer (crosslinking agent), if necessary. Specifically, the polymer may be a polymer that is crosslinked with divinylbenzene, ethyleneglycol di(meth)acrylate, diethyleneglycol di(meth)acrylate, glycidyl (meth)acrylate, 2-([1′-methylpropylideneamino]carboxyamino) ethyl (meth)acrylate, or the like. The crosslinked structure may be formed at polymerization, or the crosslinked structure may be formed after the polymer particles are formed by polymerization.

Further, the content of the crosslinking agent in a monomer mixture is preferably from 0.05 parts by weight to 20 parts by weight, and more preferably from 0.5 parts by weight to 10 parts by weight, with respect to 100 parts by weight of the total amount of the (meth)acrylate monomer and/or the styrene-based monomer.

Further, when the polymer compound in the exemplary embodiment contains a non-crosslinked polymer, the molecular weight (number average molecular weight) of the non-crosslinked polymer is preferably from 5,000 to 1,000,000, and more preferably from 10,000 to 500,000.

Furthermore, the number average molecular weight is obtained by measuring the component separated as a dissolved component using THF by means of a gel permeation chromatography (GPC). In the GPC measurement, HLC-8120GPC and SC-8020 (manufactured by TOSOH Corporation) are used, and two sets of TSK gel Super HM-H (manufactured by TOSOH corporation, 6.0 mm ID×15 cm) are used as columns, and THF (tetrahydrofuran) is used as an eluent.

Other Components

The magnetic polymer particles of the exemplary embodiment may further contain a coloring material such as a dye, a pigment, carbon black and the like, for the purpose of coloring the polymer. In this case, the coloring material can also be contained in a mixture of monomers and the like in which the fluorescent magnetic powder is dispersed, or the coloring materials may be mixed with the fluorescent magnetic powder and the monomers and the like beforehand, and the dispersion of the fluorescent magnetic powder and the dispersion of the coloring material are performed simultaneously.

Examples of the coloring materials include carbon blacks such as furnace black, channel black, acetylene black and thermal black; inorganic pigments such as red iron oxide, Prussian blue and titanium oxide; azo pigments such as fast yellow, disazo yellow, pyrazolone red, chelate red, brilliant carmine and parabrown; phthalocyanine pigments such as copper phthalocyanine, non-metal phthalocyanine; condensed multi-cyclic pigments, such as flavanthrone yellow, dibromoanthrone orange, perylene red, quinacridone red and dioxazine violet; and the like.

The magnetic polymer particles of the exemplary embodiment may be suitably used for displaying colors as described above, coloring pigments of magenta, yellow, cyan and the like may be suitably used.

More specifically, various pigments such as Chrome Yellow, Hansa Yellow, and Benzidine Yellow, Threne Yellow, Quinoline Yellow, Permanent Orange GTR, Pyrazolone Orange, Vulcan Orange, Watchyoung Red, Permanent Red, DuPont Oil Red, Lithol Red, Rhodamine B Lake, Lake Red C, Rose Bengal, Aniline Blue, Ultramarine Blue, Calco Oil Blue, Methyleneblue Chloride, Phthalocyanine Blue, Phthalocyanine Green, Malachite Green Oxalate, C. I. Pigment Red 48:1, C. I. Pigment Red 122, C. I. Pigment Red 57:1, C. I. Pigment Red 238, C. I. Pigment Yellow 12, C. I. Pigment Yellow 97, C. I. Pigment Yellow 17, C. I. Pigment Yellow 180, C. I. Pigment Yellow 74, C. I. Pigment Yellow 93, C. I. Pigment Blue 15:1, C. I. Pigment Blue 15:3, and the like can be exemplified. These pigments can be used singly, or two or more kinds of pigments cam be used in combination.

In the magnetic polymer particles of the exemplary embodiment, the content of the above coloring materials is preferably from 1 part by weight to 30 part by weight with respect to 100 parts of the polymer compound, and it is also effective to use coloring materials which are surface-treated, or to use a pigment dispersant, if necessary. A yellow toner, a magenta toner, a cyan toner, and the like can be obtained by appropriately selecting the kinds of the coloring materials.

In this case, the amount of the fluorescent magnetic powder may be decided in accordance with the color of the coloring material. The content of the fluorescent magnetic powder is preferably from 1.0% by weight to 50% by weight, and more preferably from 3.0% by weight to 30% by weight with respect to the total weight of the magnetic polymer particles.

If the content is 1.0% by weight or higher, more desirable magnetic property may be obtained. If the content is 50% by weight or lower, the luminosity and color saturation of color displayed may be further improved, when used for displaying a color.

In particular, when magnetic powder, in which iron is used as a constituent component, is used as fluorescent magnetic powder, the content of the fluorescent magnetic powder is preferably from 1.0% by weight to 5% by weight, and more preferably from 2.0% by weight to 4.0% by weight.

If the content is 1.0% by weight or higher, magnetic property may be further improved. If the content is 5% by weight or lower, the luminosity and color saturation of color displayed may be may be further improved, in particular, when used for displaying cyan color.

Moreover, when magnetic powder, in which yttrium iron garnet (Y₃Fe₅O₁₂, YIG) is used as a constituent component, is used as fluorescent magnetic powder, the content of the fluorescent magnetic powder is preferably from 1.0% by weight to 25% by weight, and more preferably from 3.0% by weight to 10% by weight.

If the content is 1.0% by weight or more, magnetic property may be further improved. If the content is 25% by weight or lower, the luminosity and color saturation of color displayed may be further improved, in particular, when used for displaying yellow color.

Further, in the magnetic polymer particles of the exemplary embodiment, when the above coloring materials are used, the weight ratio of the coloring material to the fluorescent magnetic powder (coloring material/fluorescent magnetic powder) is preferably from 10/1 to 1/10.

The magnetic polymer particles of the exemplary embodiment may further contain other resin components.

Examples of the resin components include a plastic binder resin and the like, and more specifically, a homopolymer or a copolymer of styrene (styrene-based resin) such as styrene, parachlorostyrene, and α-methyl styrene; a homopolymer or a copolymer of esters having vinyl groups (vinyl-based resin) such as methyl (meth)acrylate, ethyl (meth)acrylate, n-propyl (meth)acrylate, n-butyl (meth)acrylate, lauryl (meth)acrylate and 2-ethyl hexyl (meth)acrylate, lauryl (meth)acrylate; a homopolymer or a copolymer of vinyl nitrile (vinyl-based resin) such as acrylonitrile and methacrylonitrile; a homopolymer or a copolymer of vinyl ethers (vinyl-based resin) such as vinyl methyl ether and vinyl isobutyl ether; a homopolymer or a copolymer of vinyl ketones (vinyl-based resin) such as vinyl methyl ketone, vinyl ethyl ketone and vinyl isopropenyl ketone; a homopolymer or a copolymer of olefins (olefin-based resin) such as ethylene, propylene, butadiene and isoprene; non-vinyl condensation-based resins such as epoxy resins, polyester resins, polyurethane resins, polyamide resins, cellulose resins and polyether resins, and graft polymers of these non-vinyl condensation-based resins and vinyl-based monomers, and the like. These resins may be used singly, or two or more kinds of resins may be used in combination. In these resins, styrene-based resins, vinyl-based resins, and polyester resins, olefin-based resins are preferable, in particular, and a copolymer of styrene and n-butyl (meth)acrylate, a copolymer of n-butyl (meth)acrylate and bisphenol A/fumaric acid, and a copolymer of styrene and olefin are preferable.

Components such as releasing agents, inorganic particles, lubricants and abrasives may further be contained in the magnetic polymer particles of the exemplary embodiment, depending on the purposes. Examples of the releasing agents include low molecular weight polyolefins such as polyethylene, polypropylene and polybutene; silicones having a softening point when heated; fatty acid amides such as oleic acid amide, erucic acid amide, ricinolic acid amide, stearic acid amide; long chain aliphatic alcohols such as lauryl alcohol, stearyl alcohol, behenyl alcohol; vegetable waxes such as carnauba wax, rice wax, Candelilla wax, Japan tallow and Jojoba oil; animal waxes such as yellow beeswax; mineral and petroleum waxes such as Montan wax, ozokerite, ceresin, paraffin wax, microcrystalline wax and Fisher-Tropsch wax; and modified materials thereof.

Next, suitable manufacturing methods of the magnetic polymer particles of the exemplary embodiment will be explained.

In order to obtain the magnetic polymer particles of the exemplary embodiment, known methods can be used, for example, a suspension polymerization method, an emulsion polymerization method, a dispersion polymerization method, a seed polymerization method or the like may be suitably used. Further, the suspension polymerization may be performed using an emulsification method known as a film emulsifying method.

Specifically, for example, when the magnetic polymer particles are prepared by the suspension polymerization method, first, a mixture is prepared by adding a crosslinking agent, a polymerization initiator, and the like to a required amount of monomers for forming the polymer compound and as a magnetic component, the fluorescent magnetic powder of the exemplary embodiment.

A crosslinking agent can be selected from known crosslinking agents and can be used. Examples of the crosslinking agents include divinylbenzene, ethyleneglycol di(meth)acrylate, diethyleneglycol di(meth)acrylate, methylene bis(meth)acrylamide, glycidyl (meth)acrylate, ethyl-2-([1′-methylpropylideneamino]carboxyamino) methacrylate, and the like. In particular, divinylbenzene, ethyleneglycol di(meth)acrylate, and diethyleneglycol di(meth)acrylate are preferable, and divinylbenzene is particularly preferable.

Examples of the polymerization initiator include an azo-based polymerization initiator, and a peroxide-based initiator, and in particular, oil-soluble initiators are preferable.

Moreover, the mixture may further contain the coloring materials and the like for coloring the polymers, and other magnetic powder and the like as a magnetic component.

As the other magnetic powder, magnetite or ferrite, and the like represented by the general formula of MO.Fe₂O₃ or M.Fe₂O₄ wherein M represents a metal, which exhibits magnetism, can be suitably used.

As the manufacturing method of the mixture containing the monomer and the like, for example, first, the above monomer, a polymerization initiator, and other required components are mixed, to prepare a premixed-liquid containing the monomer and the like. The mixing method is not particularly restricted.

Subsequently, the fluorescent magnetic powder as a magnetic component is dispersed in the mixture. Known methods can be applied to the dispersion of the magnetic component in the premixed-liquid. That is, for example, dispersing machines such as a ball mill, a sand mill, an attritor and a roll mill can be used. In addition, when the monomer component is beforehand polymerized separately, and a magnetic component is dispersed in the thus obtained polymer, kneading machines such as a roll mill, a kneader, a Banbury mixer, and an extruder can be used.

In addition, the methods of producing the mixture are not limited to the above methods, and, for example, the fluorescent magnetic powder as a magnetic component may be mixed in the preparation of the premixed-liquid, and thus, a magnetic component may be contained in the premixed-liquid when preparing thereof, or alternatively, the monomer, a magnetic component, and the like are mixed at once to form the mixture.

Next, the mixture containing the monomer and the like is suspended in an aqueous medium. The suspension can be performed, for example, in the following manner.

Namely, the mixture is introduced into an aqueous medium, in which salts such as an inorganic salt and the like and a dispersion stabilizer are contained, to form a suspension. Known suspending methods can be used as the suspending method. Examples of the suspending method include mechanical methods such as a method of suspending the monomer and the like in an aqueous medium by rotating a specific stirring blade at a high speed such as a mixer, a method of suspending the monomer and the like by a shearing force by a rotor-stater known as a homogenizer, and a method of forming a suspension utilizing ultrasonic wave.

Examples of the dispersion stabilizer include inorganic dispersion stabilizers such as calcium carbonate and calcium phosphate, anionic surfactants such as a sulfuric ester sulfonic acid salt type, a phosphoric ester type, and a soap type; cationic surfactant such as an amine salt type, a quaternary ammonium salt type; and in addition to these stabilizers, nonionic surfactants such as a polyethylene glycol type, an alkyl phenol ethylene oxide adduct type, an alkyl alcohol ethylene oxide adduct type, a polyhydric alcohol type, and various graft polymers, but the stabilizers are not specifically limited thereto.

Subsequently, particles containing the monomer and the magnetic component and the like that have been suspended are subjected to a suspension polymerization to obtain magnetic polymer particles. The polymerization reaction can be performed under atmospheric pressure. Alternatively, the polymerization reaction can be performed under pressurized condition. The reaction conditions and others reaction conditions may be determined as needed basis, and are not specifically limited.

The reaction conditions, for example, such that a suspension, in which the suspension particles are dispersed, is reacted while being stirred at reaction temperatures of from 40° C. to 100° C. under atmospheric pressure for 1 hour to 24 hours, are preferable from the viewpoint of obtaining polymer particles with a yield of about 80% or more.

Moreover, when magnetic polymer particles are prepared by an emulsion polymerization method, a protective colloid layer can be formed using an unsaturated acid, for example, acrylic acid, methacrylic acid, maleic acid, styrene sulfonic acid, and the like in a small amount, so that the use of these unsaturated acids is particularly preferable, since a soap free polymerization becomes possible.

Further, as the polymerization initiators in the exemplary embodiment, an azo-based initiator, a peroxide-based initiator and the like are suitable, and a water-soluble initiator is particularly desirable.

Examples of the water-soluble azo initiator include 2,2′-azobis[N-(2-hydroxyethyl)-2-methy-propionamidine]dihydrochloride, 2,2′-azobis(2-amidinopropane)dihydrochloride, 2,2′-azobis[2-(2-imidazoline-2-il)propane]dihydrochloride, 2,2′-azobis[2-(2-imidazoline-2-il)propane], 4,4′-azobis(4-cyanovaleric acid), and the like.

Examples of the water-soluble peroxide-based initiator include ammonium persulfate, potassium persulfate, hydrogen peroxide, and the like.

The amount of addition of the polymerization initiator is not particularly restricted, but, is preferable in the range of from 0.05 part by weight to 10 parts by weight, an more preferable in the range of from 0.1 parts by weight to 5 parts by weights with respect to 100 parts by weight of the total monomer component.

The number average particle size of the magnetic polymer particles thus obtained is preferably from 0.5 μm to 20.0 μm, and more preferably from 1.0 μm to 8.0 μm. When the number average particle size is in the above range, the manufacture and handling of the particles become easy, and the fluorescent magnetic powder can effectively be taken into the particles.

In addition, the number average particle size is the value obtained in such a manner that dried particles are photographed with an optical microscope or an electron microscope, the particle sizes of 100 to 200 particles selected at random from them are measured, and the sum of the values of the particle sizes is divided by the number of the particles.

In the exemplary embodiment, the polymer compound may contain at least one kind selected from a hydroxyl group, a carboxyl group, and an alkyl ester group thereof. Thus, the dispersibility of the magnetic polymer particles in water can be greatly improved. The polymer compound can have the functional groups by selecting the monomer which constitutes the polymer compound.

In addition, the presence of each functional group can be ascertained by measuring an infrared absorption spectrum of the magnetic polymer particles, but the following method may be used, since the infrared absorption spectrum is influenced by a magnetic component and the like.

Namely, since the hydroxyl group and the carboxyl group in the magnetic polymer particles differ with magnetic components, the hydroxyl group and the carboxyl group of the polymer compound may be confirmed by obtaining the amount of the hydroxyl group and the carboxyl group of the polymer component excluding the magnetic component.

In this case, when the polymer compound has hydroxyl groups alone, the amount of the hydroxyl groups is preferably from 0.1 mmol/g to 5.0 mmol/g. When the amount of the hydroxyl groups is within this range, the polymer particles are well dispersible to an aqueous medium, without the polymer particles being swelled.

The amount of the hydroxyl groups is desirably from 0.2 mmol/g to 4.0 mmol/g, and more desirably from 0.3 mmol/g to 3.0 mmol/g.

On the other hand, when the polymer compound has carboxyl groups, the amount of the carboxyl groups is preferably from 0.005 mmol/g to 0.5 mmol/g. When the amount of the carboxyl groups is in the above range, the good dispersibility to an aqueous medium and a swelling suppressing effect can be obtained, even if the amount of carboxyl groups is small as compared with the number of the hydroxyl groups, and, these characteristics can be maintained regardless of variations with the existence of other functional groups.

The amount of the carboxyl groups is preferably from 0.008 mmol/g to 0.3 mmol/g, and more preferably from 0.01 mmol/g to 0.1 mmol/g. In addition, when the hydroxyl groups exist in this case as well, the amount of the hydroxyl groups is preferably from 0.2 mmol/g to 4.0 mmol/g, and more preferably from 0.3 mmol/g to 3.0 mmol/g.

The amount of the hydroxyl groups and the amount of the carboxyl groups can be measured according to the above method. In this case, the amount of the hydroxyl groups can be obtained, for example, in such a manner that a reagent such as a pyridine solution of acetic anhydride is added to the polymer compound and heated, and by adding water thereto to be hydrolyzed. Subsequently, after dividing into particles and a supernatant liquid with a centrifugal separator, the supernatant liquid is titrated with an ethanolic potassium hydroxide solution and the like with the use of an indicator such as phenolphthalein. On the other hand, in the case of carboxyl groups, the amount of the carboxyl groups can be obtained in such a manner that, for example, a reagent such as an ethanol solution of potassium hydroxide is added to the polymer compound to perform a neutralization reaction, thereafter, by dividing into particles and a supernatant liquid with a centrifugal separator, and the supernatant liquid containing an excess potassium hydroxide is titrated with an isopropanol hydrochloric acid solution and the like with the use of an automatic titrator.

When the carboxyl groups form a salt structure (—COO—Y⁺: here Y⁺ represents an alkali metal ion, an alkali earth metal ion, or an organic cation such as an ammonium), which will be described later, after the salt is converted into a carboxylic acid with an acid such as hydrochloric acid, the above titration can be performed so that the amount of the carboxyl groups can be obtained.

That is, the amount of the carboxyl groups in the exemplary embodiment means the amount of the carboxyl groups including the carboxyl groups which contribute to the salt structure, when the carboxyl group forms a salt structure.

<Liquid Developer for Magnetic Latent Image>

The liquid developer for magnetic latent images (hereafter, may be simply referred to as “liquid developer”) of the exemplary embodiment is a particle dispersion liquid in which the magnetic polymer particles as a toner of the above exemplary embodiment are dispersed in an aqueous medium such as water.

As the aqueous medium, water or a medium, in which a water-soluble organic solvent such as methanol and ethanol is added to water, is suitably used. In particular, water alone is desirable. In the case of adding a water-soluble organic solvent, although the amount of addition of the water-soluble organic solvent varies with the property of the magnetic polymer particles, to be dispersed is preferably 30% by weight or less, and more preferably 10% by weight or less relative to the total amount of the solvent.

At the time of manufacturing a liquid developer, various auxiliary materials which are generally used for an aqueous particle dispersion, for example, a dispersant, an emulsifier, a surfactant, a stabilizer, a wetting agent, a thickener, a foaming agent, a defoaming agent, a coagulant, a gelling agent, a sedimentation inhibitor, a charge control agent, an antistatic agent, an anti-aging agent, a softener, a plasticizer, a filler, a coloring agent, a flavoring agent, an antiadhesive agent, a releasing agent, and the like may be used together.

Specifically, as the surfactants, for example, any known surfactants such as an anionic surfactant, a nonionic surfactant and a cationic surfactant may be used. Moreover, examples of the surfactant further include silicone-based surfactants such as a polysiloxane oxyethylene adduct; fluorine-based surfactants such as perfluoroalkyl carboxylic acid salt, perfluoroalkyl sulfonate and oxyethylene perfluoroalkyl ether; biosurfactants such as spiculisporic acid, rhamnolipid, lysolecithin; and the like.

As long as the dispersant is a polymer having a hydrophilic structural moiety and a hydrophobic structural moiety, the dispersant can be effectively used. For example, a styrene-styrene sulfonic acid copolymer, a styrene-maleic acid copolymer, a styrene-methacrylic acid copolymer, a styrene-acrylic acid copolymer, a vinylnaphthalene-maleic acid copolymer, a vinylnaphthalene-methacrylic acid copolymer, a vinylnaphthalene acrylic acid copolymer, an alkylacrylate-acrylic acid copolymer, an alkyl methacrylate-methacrylic acid, a styrene-alkylmethacrylate-methacrylic acid copolymer, a styrene-alkylacrylate-acrylic acid copolymer, a styrene-phenylmethacrylate-methacrylic acid copolymer, a styrene-cyclohexyl methacrylate-methacrylic acid copolymer and the like are exemplified. These copolymers may have any structure of a random, block and graft copolymers.

Further, in the exemplary embodiment, a water-soluble organic solvent can be used for the purpose of controlling evaporativity or interface property. Examples of the water-soluble organic solvent include, the water-soluble organic solvent which is not separated into two phases, for example, monovalent or polyvalent alcohols, nitrogen-containing solvents, sulfur-containing solvents, and the derivatives thereof, and the like.

Furthermore, for the purpose of adjusting the electric conductivity, pH value, or the like, it is possible to add, to an aqueous medium, compounds of alkali metals such as potassium hydroxide, sodium hydroxide and lithium hydroxide; nitrogen-containing compounds such as ammonium hydroxide, triethanol amine, diethanol amine, ethanol amine, and 2-amino 2-methyl-1-propanol; compounds of alkali earth metals such as calcium hydroxide, acids such as sulfuric acid, hydrochloric acid and nitric acid, and salts of a strong acid and a weak alkali such as ammonium sulfate, and the like.

In addition, for the purpose of mildew prevention, preservation from decay, rust prevention, or the like, benzoic acid, dichlorophene, hexachlorophene, sorbic acid, and the like, may be added, if needed. Furthermore, an antioxidant, a viscosity controlling agent, an electric conductive agent, an ultraviolet absorption agent, a chelating agent, or the like may further be added.

In the exemplary embodiment, the particle size of the dispersed particles of the magnetic polymer particles in a liquid developer, is preferably from 0.5 μm to 20 μm, and more preferably from 1 μm to 8 μm in terms of the volume average particle size. Here, the dispersed average particle size of the magnetic polymer particles is a volume average particle size obtained by the use of COULTER COUNTER MULTISIZER 3 ((trade name) manufactured by Beckman Coulter, Inc.).

The liquid developer for magnetic latent images can be manufactured by the following procedures. However the procedures are not restricted thereto.

First, a dispersion medium containing water as main solvent and the above additives is prepared using a magnetic stirrer or the like, and the magnetic polymer particles are dispersed in the dispersion medium. Known methods are applicable to perform the dispersion. That is, dispersing machines such as a ball mill, a sand mill, attritor and a roll mill can be used. Examples of the dispersing method further include a dispersing method in which a specific stirring blade is rotated at a high speed such as a mixer, a dispersing method of using a shearing force by a rotor-stater known as a homogenizer, and a dispersing method utilizing ultrasonic wave.

After confirming as to whether the magnetic polymer particles become in a state that each particle is independently isolated in the liquid by observing a batched off dispersion sample under a microscope, additives such as antiseptics are added thereto, and it is confirmed that the additives are dissolved. The resultant dispersion is filtered, for example, with the use of a membrane filter having a pore diameter of 100 μm to remove dust and coarse particles, so that a liquid developer as an image forming recording liquid can be obtained.

Although the viscosity of the liquid developer in the exemplary embodiment varies with the image forming system to be used, the viscosity is preferably from 1 mPa·s to 500 mPa·s. When the viscosity of the liquid developer is 1 mPa·s or more, the quantity of magnetic polymer particles or the quantity of additives is sufficiently large, so that image density may be further improved. In contrast, when the viscosity of the liquid developer is 500 mPa·s or less, handling may become more easily, or developability may be further improved.

<Cartridge and Image Forming Apparatus>

Next, the process, in which the liquid developer for magnetic latent images containing the magnetic polymer particles of the exemplary embodiment is used, is explained.

The image forming process, to which the liquid developer of the exemplary embodiment is applied, is not processes such as a process utilizing an electrostatic latent image formed by a so-called electrophotographic process, a process of forming an electrostatic latent image with an ion or the like on a dielectric substance (ionography), or a process of forming an electrostatic latent image on a charged dielectric substance with the heat of a thermal head based on image information, but is a process in which a toner image is formed by forming a magnetic latent image on a image holding member (liquid magnetography), and the structure is not specifically restricted as long as a liquid developer containing an aqueous medium as a developer is used.

In the following descriptions, the image forming apparatus using a magnetic developing process, in which a liquid developer for magnetic latent images in the exemplary embodiment is used, is briefly explained.

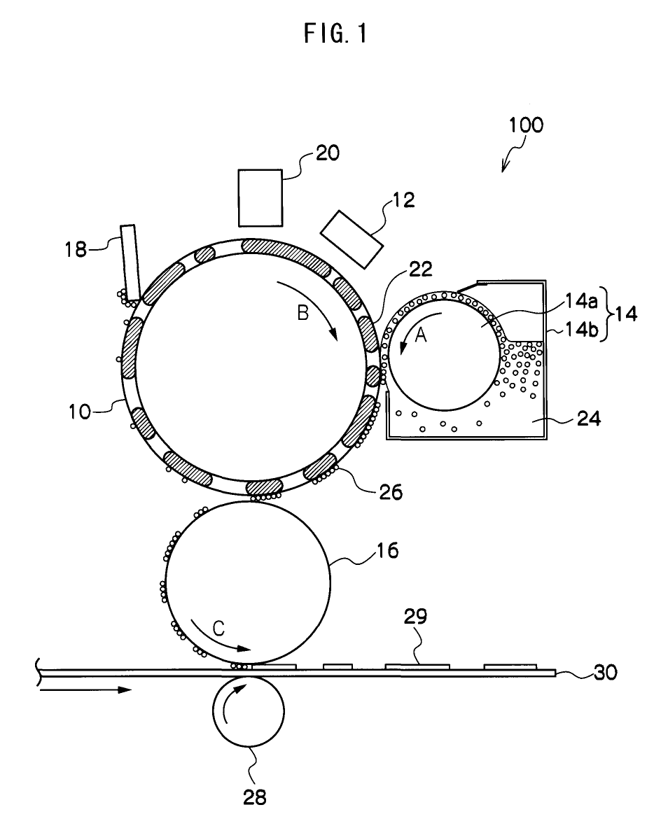

FIG. 1 is a schematic drawing illustrating an example of an image forming apparatus according to the exemplary embodiment, in which a liquid magnetographic method is used.

An image forming apparatus 100 includes a magnetic drum (magnetic latent image holding member) 10, a magnetic head (magnetic latent image forming unit) 12, a developing device (developer storage unit and developer supply unit) 14, an intermediate transfer body (transfer unit) 16, a cleaner 18, a demagnetization device (demagnetization unit) 20, and a transfer-fixing roller (transfer-fixing unit) 28. The magnetic drum 10 has a cylindrical form, and the magnetic head 12, the development device 14, the intermediate transfer body 16, the cleaner 18, and the demagnetization device 20 are arranged on the peripheral surface of the magnetic drum 10, sequentially.

Hereafter, the operation of the image forming apparatus 100 will be briefly described.

First, the magnetic head 12 connected to an information device (not illustrated), for example, receives binarized image data which are transmitted from the information device. The magnetic head 12 emits a magnetic line of force while scanning the side surface of the magnetic drum 10 to form a magnetic latent image 22 on the magnetic drum 10. Here, in FIG. 1, the magnetic latent image 22 is shown by the portions illustrated by slant lines on the magnetic drum 10.

The developing device 14 includes a developing roller (developer supply unit) 14a and a developer storage container (developer storage unit) 14b. The developing roller 14a is configured such that a part of the roller 14a is immersed in a liquid developer 24 stored in the developer storage container 14b.

Here, the developing device 14 equipped with the developing roller (developer supply unit) 14a and the developer storage container (developer storage unit) 14b is an example of the cartridge of the exemplary embodiment.

The liquid developer 24 includes an aqueous medium and toner particles. The toner particles are magnetic toner (magnetic polymer particles) containing a magnetic body therein. Details of the aqueous medium or toner particles are described hereinbefore.

The toner particles are homogeneously dispersed in the liquid developer 24, and, the liquid developer 24 is continuously stirred by a stirring member provided in the developer storage container 14b with a predetermined revolving speed, so that variation in the toner concentration with the location in the liquid developer 24 can be further suppressed. Thus, the liquid developer 24 with the suppressed variation in concentration of toner particles is supplied to the developing roller 14a, which rotates in the direction of an arrow A in the drawing.

The liquid developer 24 supplied to the developing roller 14a is conveyed to the magnetic drum 10 in the state that the liquid developer is regulated to a certain supply amount with a regulating member, which will be described later, and the liquid developer is supplied to the magnetic latent image 22 at the position where the developing roller 14a comes close to (or comes into contact with) the magnetic drum 10, thereby visualizing the magnetic latent image 22 to form a toner image 26.

Although the developed toner image 26 is conveyed by the magnetic drum 10 which rotates in the direction of an arrow B in the drawing, and is transferred to paper (recording medium) 30 in the image forming apparatus, the toner imager is temporarily transferred to the intermediate transfer body 16 before transferring to the paper 30, for the purpose of improving the transfer efficiency including the stripping efficiency of the toner image from the magnetic drum 10 to the recording medium, and performing the transfer and fixation of the toner image to the recording medium simultaneously.

Since the toner particles are not substantially electrically charged, the transfer of the toner particles to the intermediate transfer body 16 is preferably performed by a searing transfer (non-electric field transfer) method. Specifically, the magnetic drum 10 rotating in the direction of the arrow B is brought into contact with the intermediate transfer body 16 rotating in the direction of an arrow C with a predetermined nip (contact surface having a contact width in the direction of movement), and the toner image 26 is transferred to the intermediate transfer body with an adsorption power higher than the magnetic force with the magnetic drum 10 with respect to the toner image 26. At this time, a difference in peripheral speeds between the magnetic drum 10 and the intermediate transfer body 16 may be provided.

Subsequently, the toner image conveyed in the direction of the arrow C with the intermediate transfer body 16 is transferred to the paper 30 at the contact position with the transfer-fixing roller 28, and is simultaneously fixed to form a fixed image 29.

The paper 30 is nipped between the intermediate transfer body 16 and the transfer-fixing roller 28, and the toner image on the intermediate transfer body 16 is brought into close contact with the paper 30. Thus, the toner image can be transferred to the paper 30 and can be fixed on the paper at the same time. Since the liquid developer for magnetic latent images of the exemplary embodiment is used as a developer, the toner image can be fixed only with pressurization without heating. In this case, the pressing force to the intermediate transfer body 16 by the transfer-fixing roller 28 is desirably from 0.05 MPa to 10 MPa. Further, when an independent fixing device different from this exemplary embodiment, is independently provided, for example, the pressing force between fixing rollers may be substantially equal to the above.

On the other hand, in the magnetic drum 10 which has transferred the toner image 26 onto the intermediate transfer body 16, residual toner remained on the surface of the drum is conveyed to the contact position with a cleaner 18, and is recovered with the cleaner 18. The magnetic drum 10 with the magnetic latent image 22 rotates to a demagnetization position after cleaning.

The demagnetization device 20 demagnetizes the magnetic latent image 22 formed on the magnetic drum 10. The magnetic drum 10 is returned to the state where the magnetic layer does not vary in the magnetized state same as in the state before image formation with the cleaner 18 and the demagnetization device 20. By repeating the above operation, images transmitted successively from the information device are formed continuously in a short period of time. In addition, all the magnetic head 12, the developing device 14, the intermediate transfer body 16, the transfer-fixing roller 28, the cleaner 18, and the demagnetization device 20 provided in the image forming apparatus 100 are operated in synchronization with the revolving speed of the magnetic drum 10.

In the image forming apparatus, a water repellent magnetic drum 10 as a magnetic latent image holding body may be used. The water repellence refers to a water-repulsive property, and more specifically, the contact angle of the surface with pure water is 70° or more.

Further, the contact angle of the surface of the magnetic drum 10 is a value obtained in such a manner that using a contact angle meter (CA-X (trade name) manufactured by Kyowa Interface Science Co., Ltd.), 3.1 μl of pure water is dropped on the surface of the magnetic drum under the environment of 25° C. and 50% RH, and a contact angle at 15 seconds after the drop is measured.

### EXAMPLES

Hereafter, the present invention will be explained with reference to examples, but the invention is not restricted to the examples. In addition, “part” and “%” mean “parts by weight” and “% by weight”, respectively, unless otherwise specified.

<Manufacture of Fluorescent Magnetic Powder>

(Fluorescent Magnetic Powder 1)

Hydrophobizing Treatment of the Surface of Particles of Magnetic Powder

A silane coupling agent (3-methacryloxypropyl trimethoxy silane) (2 parts) is added to 100 parts of ethanol (95%) aqueous solution the pH value of which has been adjusted to the range from 4.5 to 5.5 with acetic acid, and the mixture is stirred. To this mixture, 100 parts of iron powder particles having an iron oxide surface (manufactured by JFE Steel Corporation; superfine iron powder, average primary particle size: 0.8 μm) are added, the resultant mixture is dispersed by an ultrasonic dispersing machine (application conditions: 10 kHz and 200 W) for 5 minutes, is allowed to stand for 30 minutes and is filtered to remove solvent, and the filtered product is dried.

Formation of Resin Layer

Under nitrogen atmosphere, components of the following composition are mixed to prepare a monomer-mixed solution.

| | |
|---|---|
| Polymerization initiator (V-601(trade name); manufactured | 1.5 parts |
| by Wako Pure Chemical Industries, Ltd.): | |
| Styrene (manufactured by Wako Pure Chemical Industries, | 4.5 parts |
| Ltd.): | |
| Butyl methacrylate (manufactured by Wako Pure Chemical | 18.5 parts |
| Industries, Ltd.): | |
| Mono-2-(methacryloxy)ethyl phthalate (ACRYESTER PA | 72.0 parts |
| (trade name); manufactured by Mitsubishi Rayon Co., Ltd.): | |
| Toluene (manufactured by Wako Pure Chemical Industries, | 500 parts |
| Ltd.): | |

The hydrophobized iron powder (100 parts) is added to the monomer-mixed solution to react at 65° C. for 20 hours. After completion of the reaction, the reaction liquid is subjected to centrifugal separation, the filtered product is washed with toluene and THF, and is vacuum-dried. The amount of acidic groups is measured and a value of 2.4 mmol/g is obtained.

Attachment of Fluorescent Dye

After 1.0 parts of sodium hydroxide is added to 400 parts of ion exchange water and is dissolved, 100 parts of particles of the magnetic powder, on which the resin layer is formed, is mixed therewith, and the carboxyl groups of the surface of the resin layer are neutralized while the mixture is being ground with a ball mill for 24 hours. After completion of the reaction, the reaction liquid is centrifuged, and the separated product is washed repeatedly with ion exchange water.

After dispersing the magnetic powder which has been subjected to the neutralization treatment in 400 parts of ion exchange water again, 1.2 parts of Rhodamine B (manufactured by Wako Pure Chemical Industries, Ltd.) that is a xanthene-based fluorescent dye is added thereto. The mixture is stirred for one hour to attach the fluorescent dye to the surface of the particles of the magnetic powder through a salt exchange reaction. Subsequently, after separating a solid component with centrifugal separation, the solid component is washed repeatedly with ion exchange water to obtain fluorescent magnetic powder 1.

Characteristics of Fluorescent Magnetic Powder

Confirmation of Attachment

The obtained fluorescent magnetic powder 1 is subjected to a Soxhlet extraction for 6 hours using ion exchange water as a solvent. As a result, the change in weight between the weight of the fluorescent magnetic powder after the extraction and the weight before the extraction is 0.5% by weight. Similarly, the Soxhlet extraction is performed for 6 hours, using acetone as a solvent. As a result, the change in weight between the weight after the extraction and the weight before the extraction is 3.5% by weight.

Amount of Attached Components

The amount of components (amount of attached components) other than the magnetic powder of the fluorescent magnetic powder 1 is measured by a thermogravimetric analytic method. Specifically, the sample is placed on the sample tray of a thermogravimetric apparatus ((TGA-50) trade name; manufactured by Shimadzu Corporation), and, is heated from room temperature (20° C.) to 600° C. at a heating rate of 10° C./minute under nitrogen atmosphere. Thereafter, the sample is weighed again, and a decrease ratio due to heating is measured. As a result, the amount of attached components is 15% by weight.

(Fluorescent Magnetic Powder 2)

Fluorescent magnetic powder 2 is prepared in a manner similar to the manufacture of the fluorescent magnetic powder 1 except that YIG powder (average primary particle size: 0.6 μm; manufactured by Kojundo Chemical Laboratory Co., Ltd.) is used in place of iron powder as magnetic powder, in the hydrophobizing treatment of the surface of the magnetic powder particles, and C. I. Basic Yellow 40 in place of Rhodamine B as the fluorescent dye is used in the attachment of the fluorescent dye.

Further, the attachment is confirmed and the amount of attached components is measured with respect to the fluorescent magnetic powder 2 in a manner similar to the above. After the Soxhlet extraction, the change in weight is 0.8% by weight with the use of ion exchange water, and the change in weight with the use of acetone is 3.0% by weight, and the amount of attached components is 20% by weight by TGA.

(Fluorescent Magnetic Powder 3)

Fluorescent magnetic powder 3 is prepared in a manner similar to the manufacture of the fluorescent magnetic powder 1 except that 0.45 part of styrene (product of Wako Pure Chemical Industries, Ltd.), 1.85 parts of butyl methacrylate (product of Wako Pure Chemical Industries, Ltd.), and 7.2 parts of mono-2-(methacryloxy) ethyl phthalate (ACRYESTER PA (trade name); manufactured by Mitsubishi Rayon Co., Ltd.) are used, in forming the resin layer.

The attachment is confirmed and the amount of attached components is measured with respect to the fluorescent magnetic powder 3 in a manner similar to the above. After the Soxhlet extraction, the change in weight is 0.1% by weight with the use of ion exchange water, and the change in weight with the use of acetone is 0.8% by weight, and the amount of attached components is 1.5% by weight by TGA.

(Fluorescent Magnetic Powder 4)

Fluorescent magnetic powder 4 is prepared in a manner similar to the manufacture of the fluorescent magnetic powder 1 except that 45 part of styrene (product of Wako Pure Chemical Industries, Ltd.) 185 parts of butyl methacrylate (product of Wako Pure Chemical Industries, Ltd.), and 720 parts of mono-2-(methacryloxy)ethyl phthalate (ACRYESTER PA (trade name); manufactured by Mitsubishi Rayon Co., Ltd.) are used, in forming the resin layer.

The attachment is confirmed and the amount of attached components is measured with respect to the fluorescent magnetic powder 4 in a manner similar to the above. The change in weight after the Soxhlet extraction is 1.2% by weight with the use of ion exchange water, and the change in weight with the use of acetone is 5.0% by weight, and the amount of attached components is 55% by weight by TGA.

### Example A-1

(Preparation of Color Magnetic Ink Composition)

Fluorescent magnetic powder 1 (5 parts) and 10 parts of Carmine 6B are mixed, and the mixture is added to 67 parts of a varnish for printing ink (rosin-modified phenol resin-based varnish; non-volatile component: 70%), and the resultant mixture is kneaded with a three-roll kneader three times to obtain a base ink. Further, 19 parts of the varnish for printing ink, 6 parts of No. 7 Solvent (petroleum-based solvent manufactured by Nippon Oil Corporation), and 10 parts of a compound (ink adjustment auxiliary) are further added to the base ink, and thus the color magnetic ink composition 1 is prepared.

(Evaluation of Color Magnetic Ink Composition)

The color magnetic ink composition is applied onto a blank sheet of paper with the use of a blade coater. Meanwhile, a color ink composition having the same composition as the above ink composition except that the fluorescent magnetic powder 1 is not contained, is prepared, and is applied onto a blank sheet of paper. Each sheet of paper on which the ink composition has been applied exhibits light red.

The color space of each coated sheet of paper is evaluated based on the color reproduction measurement value (L*, a*, b*), and visual inspection, respectively. Here, each numerical value of the L*, a* and b* is measured with a spectrometer (938 Spectrodentitometer (trade name); manufactured by X-Rite, Inc.). From the measurement results, a value of ΔE (color difference) 9.0 is obtained.

The above ΔE (color difference) is obtained by {(L₀*−L₁*)²+(a₀*−a₁*)²+(b₀*−b₁*)²}^{1/2}. Here, L₀*, a₀* and b₀* each represent the measured value of the sample of the color ink composition which does not contain the magnetic powder, and L₁*, a₁* and b₁* each represent the measured value of the sample of the color magnetic ink composition which contains the magnetic powder.

### Example A-2

(Preparation of Color Magnetic Ink Composition)

Fluorescent magnetic powder 2 (15 parts), 10 parts of C. I. Pigment Yellow 185 ((trade name) manufactured by BASF) are mixed, and the mixture is added to 67 parts of a varnish for printing ink (rosin-modified phenol resin-based varnish; non-volatile component: 70%), and the resultant mixture is kneaded with a three-roll kneader three times to obtain a base ink. Further, the varnish for printing ink (19 parts), 6 parts of No. 7 Solvent (petroleum-based solvent manufactured by Nippon Oil Corporation), and 10 parts of a compound (ink adjustment auxiliary) are further added to the base ink, and thus the color magnetic ink composition 2 is prepared.

(Evaluation of Color Magnetic Ink Composition)

Each of the color magnetic ink composition 2, and a color ink composition which does not contain the fluorescent magnetic powder 2 is applied onto a blank sheet of paper. Each sheet of paper on which the ink composition has been applied exhibits light yellow.

Further, the evaluations are performed in a manner similar to Example A-1. From the measurement results, a value of ΔE (color difference) 5.5 is obtained.

### Comparative Example A-1

A comparative magnetic powder 1 is prepared in the same manner as the fluorescent magnetic powder 1 until the step of the resin layer formation.

A color magnetic composition is prepared in a manner similar to the preparation of the color magnetic composition in Example A-1 except that the comparative magnetic powder 1 is used in place of the fluorescent magnetic powder 1, and the evaluations are performed in a similar manner to the evaluations in Example A-1.

As a result, the color tinge of each sheet of paper on which the ink composition has been applied is dim and dark red, and a value of ΔE (color difference) 15 is obtained.

### Comparative Example A-2

A comparative magnetic powder 2 is prepared in the same manner as the fluorescent magnetic powder 2 until the step of the resin layer formation.

A color magnetic composition is prepared in a manner similar to the preparation of the color magnetic composition in Example A-2 except that the comparative magnetic powder 2 is used in place of the fluorescent magnetic powder 2, and the evaluations are performed in a similar manner to the evaluations in Example A-2.

As a result, the color tinge of each sheet of paper on which the ink composition has been applied is dim and dark yellow, and a value of ΔE (color difference) 11 is obtained.

### Example B-1

(Manufacture of Magnetic Polymer Particles)

Thirty six parts of n-butyl methacrylate (manufactured by Wako Pure Chemical Industries, Ltd.), 38 parts of styrene monomer (manufactured by Wako Pure Chemical Industries, Ltd.), and 11 parts of styrene-acrylic resin (S-Lec P-SE-0020 (trade name); manufactured by Sekisui Chemical Co., Ltd.) are mixed together, and 5 parts of the fluorescent magnetic powder 1 and 10 part of red pigment Carmine 6B are added to the mixture, and the resultant mixture is dispersed by a ball mill for 24 hours. Five parts of azobis isobutylonitrile (manufactured by Wako Pure Chemical Industries, Ltd.) as a polymerization initiator is added to 90 parts of the mixed liquid containing the magnetic component, and thus a mixture containing the monomers and the fluorescent magnetic powder is prepared.

Meanwhile, 30 parts of calcium carbonate (Luminous (trade name) manufactured by Maruo Calcium Co., Ltd.) as a dispersion stabilizer and 3.5 parts of carboxymethyl cellulose (CELLOGEN (trade name) manufactured by Dai-Ichi Kogyo Seiyaku Co., Ltd) are added to an aqueous solution in which 28 parts of sodium chloride (manufactured by Wako Pure Chemical Industries, Ltd.) is dissolved in 160 parts of ion exchange water, and the mixture is dispersed with a ball mill for 24 hours to form a dispersion medium.

The aforementioned mixture is added to 200 parts of the dispersion medium, and emulsified for 3 minutes at 8,000 rpm with an emulsifying apparatus (HIGH-FLEX HOMOGENIZER (trade name); manufactured by SMT Co., Ltd.), to form a suspension.

Nitrogen gas is introduced into a separable flask equipped with a stirrer, a thermometer, a condenser tube and a nitrogen introduction pipe, through the nitrogen introduction pipe. Thus, the inside of the flask is brought to nitrogen gas atmosphere. The suspension is introduced into the flask, and allowed to react at 65° C. for 3 hours, and further is heated at 70° C. for 10 hours, and thereafter is cooled. The reaction liquid forms a good dispersion, and aggregates are not observed visually during polymerization.

After adding 10% aqueous hydrochloric acid solution to the reaction liquid to decompose the calcium carbonate, the liquid is centrifuged to perform a solid-liquid separation. After washing the obtained particles with one liter of ion exchange water 3 times repeatedly, particles in which magnetic powder is not contained and particles in which too much magnetic powder is contained are removed with a magnetic separator at different magnetic forces. After vacuum-drying the obtained particles at 40° C., coarse particles and fine particles are removed with an air blow particle classifier (Elbow-Jet), and magnetic polymer particles 1 having a number average particle size of 5.0 μm are obtained. The magnetic force of the particles is measured with a VSM magnetic property measurement machine, the content of magnetic powder is calculated, and a value of 4.5% by weight is obtained.

(Preparation of Liquid Developer for Magnetic Latent Images)

After 5 parts of polyvinyl alcohol ((PVA) KURARAY POVAL 217 (trade name); polymerization degree: 1700 and saponification degree: 88 mol %; manufactured by Kuraray Co., Ltd.) are added to 95 parts of cooled ion exchange water, and dispersed with stirring by a magnetic stirrer, and further heated in a water bath at 70° C. with stirring for 3 hours, and an aqueous PVA solution (5% solution) is prepared.

| | |
|---|---|
| Magnetic polymer particles 1: | 5 parts |
| Aqueous PVA solution: | 10 parts |
| Polyoxyethylene (20) cetylether (manufactured by | 0.5 part |
| Wako Pure Chemical Industries, Ltd.): | |
| Ion exchange water: | 84.5 parts |

The above components are mixed, dispersed with a ball mill for 3 hours, and a liquid developer 1 for magnetic latent images is obtained. Here, in the process of preparing the liquid developer, particles neither float on the surface of water, nor deposit on the wall surface of the container, and all the particles are well re-dispersed in water, and the dispersibility is good.

(Evaluation of Characteristics with Use of Actual Machine)

An image forming apparatus 100 having a configuration as shown in FIG. 1, with the use of a magnetic drum of a commercially available magnetic printer (Model MG-8100 (trade name), manufactured by Iwatsu Electric Co., Ltd.) is prepared, and images are evaluated using the liquid magnetic developer 1 for magnetic latent images as a developer.

Here, a four channel full-line magnetic head capable of forming pixels equivalent to 600 dpi formed from a Mn—Zn ferrite as a magnetic head 12 is prepared.

A developing device 14, which has a magnetic roll having a non-magnetic sleeve made of aluminum in which cylindrical permanent magnets are disposed concentrically, as a developing roller 14a, and has a developer storage container 14b in which stirring blades for stirring a liquid developer is provided therein, is used.

The liquid developer 1 for magnetic latent images is placed in the developer storage container 14b, and the developing device 14 is arranged such that the gap of the surface of the non-magnetic sleeve and the surface of the magnetic drum 10 is 50 μm.

As an intermediate transfer body 16, an intermediate transfer drum made of aluminum, on the surface of which a silicone rubber layer having a thickness of 7.5 mm is provided, rotating with the same peripheral speed as the speed of the magnetic drum 10, is used. Further, as a transfer-fixing roller 28, an elastic roll formed by covering a silicone rubber layer and a fluororubber layer in this order on the peripheral surface of a core material made of stainless steel, is used.

Printing conditions with the use of the image forming apparatus 100 having the above configuration are set to the following conditions:

| | |
|---|---|
| Linear velocity of magnetic drum: | 100 mm/second |
| Ratio of peripheral speed of developing roller/ | 1.2 |
| peripheral speed of magnetic drum: | |
| Transfer conditions (intermediate transfer): | 0.147 MPa (1.5 kgf/cm²) |
| pressing pressure of intermediate transfer | |
| body against magnetic drum: | |
| Transfer-fixing conditions: pressing pressure of | 0.245 MPa (2.5 kgf/cm²) |
| transfer-fixing roller against intermediate | |
| transfer body: | |
| Surface temperature of transfer-fixing roller: | 140° C. |

According to the above conditions, a magnetic latent image equivalent to a solid image (20 mm×50 mm) is formed on the magnetic drum 10 by the magnetic head 12, the liquid developer is brought into contact with the latent image by using the developing roller to perform development and transfer-fixing. On the other hand, a liquid developer having the same composition except that the fluorescent magnetic powder 1 is not contained therein is produced, and image formation is performed by the use of the image forming apparatus 100 in a manner similar to the above. Each image after transfer-fixing is light red.

Further, the color spaces of both the fixed images are evaluated based on the color reproduction measurement value (L*, a* and b*) and visual inspection, respectively. Here, each numerical value of the L*, a* and b* is measured with a spectrometer (938 Spectrodentitometer (trade name); manufactured by X-Rite, Inc.). From the measurement results, a value of ΔE (color difference) 8.5 is obtained.

The above ΔE (color difference) is obtained by {(L₀*−L₁*)²+(a₀*−a₁*)²+(b₀*−b₁*)²}^{1/2}. Here, L₀*, a₀* and b₀* each represent the measured value of the sample of the liquid developer which does not contain the magnetic powder, and L₁*, a₁* and b₁* each represent the measured value of the sample of the liquid developer which contains the magnetic powder.

### Example B-2

(Manufacture of Magnetic Polymer Particles)

Fluorescent magnetic powder 2 (25 parts) and 10 parts of yellow pigment C. I. Pigment Yellow 185 ((trade name) manufactured by BASF) are added to 65 parts of a styrene acrylic resin (S-Lec P-SE-0020 (trade name); manufactured by Sekisui Chemical Co., Ltd.), and the mixture is kneaded by a pressurizing kneader. After roughly milled the kneaded product, the milled product is jet-mill pulverized. The pulverized product is temporarily dispersed in ion exchange water, and particles in which magnetic powder is not contained and particles in which too much magnetic powder is contained are removed with a magnetic separator at different magnetic forces. After the obtained magnetic polymer particles are dried in a manner similar to Example B-1, and coarse particles and fine particles are removed with an air blow particle classifier (Elbow-Jet), and magnetic polymer particles 2 having a number average particle size of 5.0 μm are obtained. The magnetic force of the particles is measured with a VSM magnetic property measurement machine, the content of magnetic powder is calculated, and a value of 22% by weight is obtained.

(Evaluation of Characteristics with Use of Actual Machine)

Two kinds of liquid developer are prepared in a manner similar to Example B-1. One is prepared with the use of the magnetic polymer particles 2 and the other is prepared with the use of magnetic polymer particles which do not contain the fluorescent magnetic powder 2. Images are formed by the use of the image forming apparatus 100 in a manner similar to Example B-1. Each image after transfer-fixing is light yellow.

Further, the color tinge is evaluated in a manner similar to Example B-1, and a value of ΔE (color difference) 6.5 is obtained.

### Example B-3

Magnetic polymer particles 3 having a number average particle size of 5 μm is obtained in a manner similar to the manufacture of the magnetic polymer particles of Example B-1 except that fluorescent magnetic particles 3 is used in place of the fluorescent magnetic powder 1. When the magnetic force of particles is measured by the use of a VSM magnetizing property measurement machine and the content of magnetic powder is calculated, a value of 4.5% by weight is obtained.

Two types of liquid developer are prepared in a manner similar to Example B-1. One is prepared with the use of the magnetic polymer particles 3, and the other is prepared with use of magnetic polymer particles which do not contain iron powder or Rhodamine B. Images are formed by the use of the image forming apparatus 100 in a manner similar to Example B-1. The image after transfer-fixing the sample formed with the use of the liquid developer containing the magnetic polymer particles which do not contain iron powder is light red, but the image formed with the use of the liquid developer containing the magnetic polymer particles 3 is slightly dark red.

Further, the color tinge is evaluated in a manner similar to Example B-1, and a value of ΔE (color difference) 10 is obtained.

### Example B-4

Magnetic polymer particles 4 having a number average particle size of 5 μm is obtained in a manner similar to the manufacture of the magnetic polymer particles in Example B-1 except that fluorescent magnetic powder 4 is used in place of the fluorescent magnetic powder 1. The magnetic force of particles is measured by the use of a VSM magnetizing property measurement machine, the content of magnetic powder is calculated, and a value of 4.5% by weight is obtained.

Two types of liquid developer are prepared in a manner similar to Example B-1. One is prepared with the use of the magnetic polymer particles 4, and the other is prepared with the use of magnetic polymer particles which do not contain iron powder or Rhodamine B. Images are formed by the use of the image forming apparatus 100 in a manner similar to Example B-1. The image after transfer-fixing the sample formed with the use of the liquid developer containing the magnetic polymer particles which do not contain iron powder is light red, but the image formed with the use of the liquid developer containing the magnetic polymer particles 4 is light bright red.

Further, the color tinge is evaluated in a manner similar to Example B-1, and a value of ΔE (color difference) 9.5 is obtained.

### Comparative Example B-1

Magnetic polymer particles 5 having a number average particle size of 5 μm is obtained in a manner similar to the manufacture of the magnetic polymer particles of Example B-1 except that, for polymerization, 5 parts of iron powder (manufactured by JFE Steel Corporation; superfine iron powder) and 10 parts of Rhodamine B are added in place of the fluorescent magnetic powder 1. The magnetic force of particles is measured by the use of a VSM magnetizing property measurement machine, the content of magnetic powder is calculated, and a value of 4.5% by weight is obtained.

Two types of liquid developer are prepared in a manner similar to Example B-1. One is prepared with the use of the magnetic polymer particles 5, and the other is prepared with the use of magnetic polymer particles which do not contain iron powder or Rhodamine B. Images are formed by the use of the image forming apparatus 100 in a manner similar to Example B-1. The image after transfer-fixing the sample formed with the use of the liquid developer containing the magnetic polymer particles that do not contain iron powder is light red, but the image formed with the use of the magnetic polymer particles 5 is dark red.

Further, the color tinge is evaluated in a manner similar to Example B-1, and a value of ΔE (color difference) 15 is obtained.

### Comparative Example B-2

Magnetic polymer particles 6 having a number average particle size of 5 μm is obtained in a manner similar to the manufacture of the magnetic polymer particles of Example B-2 except that 25 parts of YIG powder (manufactured by Kojundo Chemical Laboratory Co., Ltd.) and 10 parts of C. I. Basic Yellow 40 are added and knead-pulverized in place of the fluorescent magnetic powder 2. The magnetic force of particles is measured by the use of a VSM magnetizing property measurement machine, the content of magnetic powder is calculated, and a value of 22% by weight is obtained.

Two types of liquid developer are prepared in a manner similar to Example B-1. One is prepared with the use of the magnetic polymer particles 6, and the other is prepared with the use of magnetic polymer particles which do not contain YIG powder or C. I. Basic Yellow 40, and images are formed by the use of the image forming apparatus 100. The image after transfer-fixing the sample formed with the use of the liquid developer containing the magnetic polymer particles that do not contain the YIG powder is light yellow, but the image formed with the use of the liquid developer containing the magnetic polymer particles 6 is dark yellow.

Further, the color tinge is evaluated in a manner similar to Example B-1, and a value of ΔE (color difference) 18 is obtained.

As described above, since the fluorescent magnetic powder in which a fluorescent dye is attached to the surface of the particles of the magnetic powder, are used in the examples, the hiding effect due to fluorescence as an ink composition or magnetic polymer particles is high, and a display and image without a decrease in the luminosity and color saturation can be obtained. On the other hand, in the comparative examples using an ink composition and magnetic particles in which a fluorescent dye is not attached to the particles of the magnetic powder, some problems arise in color tinge and the like.

The forgoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. Fluorescent magnetic powder comprising magnetic powder and a fluorescent dye that is attached to particles of the magnetic powder.

2. The fluorescent magnetic powder according to claim 1, wherein the fluorescent dye is attached to the particles of the magnetic powder via a resin provided on the surface of the particles of the magnetic powder.

3. The fluorescent magnetic powder according to claim 2, wherein the resin has a functional group, and the fluorescent dye is attached to the magnetic powder by reaction with the functional group of the resin.

4. The fluorescent magnetic powder according to claim 2, wherein components of the fluorescent magnetic powder other than the magnetic powder are from about 5.0% by weight to about 50% by weight with respect to the total amount of the fluorescent magnetic powder.

5. A magnetic ink composition comprising:
the fluorescent magnetic powder according to claim 1 and a vehicle.

6. The magnetic ink composition according to claim 5, wherein the fluorescent dye is attached to the particles of the magnetic powder via a resin provided on the surface of the particles of the magnetic powder.

7. The magnetic ink composition according to claim 5, further comprising a pigment.

8. Magnetic polymer particles comprising:
the fluorescent magnetic powder according to claim 1, dispersed in a binder resin.

9. The magnetic polymer particles according to claim 8, wherein the fluorescent dye is attached to the particles of the magnetic powder via a resin provided on the surface of the particles of the magnetic powder.

10. The magnetic polymer particles according to claim 8, further comprising a pigment.

11. A liquid developer for magnetic latent images comprising:
the magnetic polymer particles according to claim 8 and an aqueous medium.

12. The liquid developer for magnetic latent images according to claim 11, wherein the fluorescent dye is attached to the particles of the magnetic powder via a resin provided on the surface of the particles of the magnetic powder.

13. A cartridge comprising:
a developer storage unit for storing a liquid developer, and
a developer supply unit for supplying the liquid developer to the outside, wherein the liquid developer is the liquid developer for magnetic latent images according to claim 11.

14. The cartridge according to claim 13, wherein in the liquid developer, the fluorescent dye is attached to the particles of the magnetic powder via a resin provided on the surface of the particles of the magnetic powder.

15. An image forming apparatus comprising:
a magnetic latent image holding member;
a magnetic latent image forming unit that forms a magnetic latent image on the magnetic latent image holding member;
a developer storage unit that stores a liquid developer containing a magnetic toner and an aqueous medium; and,
a developer supply unit that supplies the liquid developer to the magnetic latent image holding member on which the magnetic latent image is formed in order to visualize the magnetic latent image as a toner image; wherein,
the liquid developer is the liquid developer for magnetic latent images according to claim 11.

16. The image forming apparatus according to claim 15, wherein in the liquid developer, the fluorescent dye is attached to the particles of the magnetic powder via a resin provided on the surface of the particles of the magnetic powder.

17. A method for manufacturing fluorescent magnetic powder comprising:
hydrophobizing the surface of particles of magnetic powder by treating the surface with a coupling agent;
forming a resin having a functional group on the hydrophobized surface of the particles of the magnetic powder; and,
attaching a fluorescent dye to the particles of the magnetic powder by reacting the fluorescent dye with the functional group of the resin.

18. The method for manufacturing fluorescent magnetic powder to claim 17, wherein components of the fluorescent magnetic powder other than the magnetic powder are from about 5.0% by weight to about 50% by weight with respect to the total amount of the fluorescent magnetic powder.

19. The method of manufacturing fluorescent magnetic powder according to claim 17, wherein the coupling agent is a silane coupling agent containing a polymerizable group represented by Formula (1); 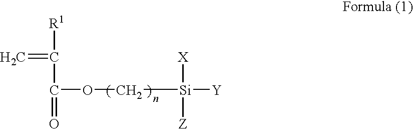
where, n represents an integer of from 1 to 18, R¹ represents a hydrogen atom or a methyl group, and X, Y, and Z each independently represent a halogen atom, an alkyl group or an alkoxy group.

20. The method of manufacturing fluorescent magnetic powder according to claim 17, wherein the resin comprises a resin formed by polymerizing at least one monomer represented by Formula (2) or Formula (3); 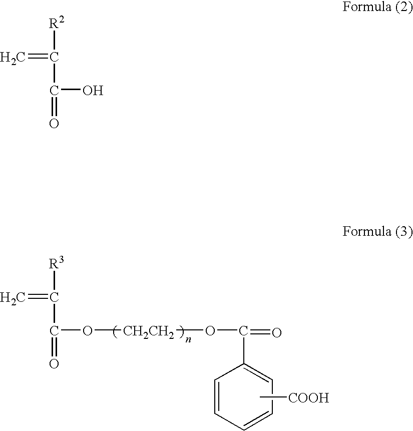
where, R² and R³ each independently represent a hydrogen atom or a methyl group, and n represents an integer of from 1 to 18.
